(19) United States
(12) Patent Application Publication
(10) Pub. No.: US 2021/0317846 A1
(43) Pub. Date: Oct. 14, 2021

(54) SYSTEM FOR CHARGING AND DISCHARGING AT LEAST ONE HYDRAULIC ACCUMULATOR

(71) Applicant: HYDAC FLUIDTECHNIK GMBH, Sulzbach/Saar (DE)

(72) Inventors: Peter BRUCK, Althornbach (DE); Christian STAUCH, Schwalbach (DE)

(21) Appl. No.: 17/267,554

(22) PCT Filed: Jul. 30, 2019
(86) PCT No.: PCT/EP2019/070474

§ 371 Date: Feb. 10, 2021

(30) Foreign Application Priority Data
Aug. 11, 2018 (DE) 10 2018 006 380.2

(51) Int. Cl. F15B 1/033

(52) U.S. Cl. CPC F15B 1/033

(57) ABSTRACT

A system for charging and discharging at least one hydraulic accumulator (10), which can be connected to a valve control device (12), wherein the valve control device (12) comprises at least one logic valve (14), is characterized in that a shuttle valve (16) and a switching valve (18) are also provided and the valves (14, 16, 18) are interconnected such that the hydraulically actuatable switching valve (18) compares the accumulator pressure (p_{A}) to a minimum accumulator pressure (p_{A0}) that can be adjusted via the control pressure setting of this switching valve (18).

The invention relates to a system for charging and discharging at least one hydraulic accumulator that can be connected to a valve control device, wherein the valve control device comprises at least one logic valve. More particularly, the invention relates to a system provided for controlling the charge state of hydraulic accumulators used for hydraulic hybrid applications for the intermediate storage and subsequent recovery of excess hydraulic energy.

In hydraulic systems, excess energy, for instance braking energy or potential energy, gained when lowering loads, wherein said energy is temporarily stored in the hydraulic accumulator, can be recovered to support or unload drive units for hydraulic consumers, such as drives or working cylinders. For this purpose, depending on the system status and the charge state of the hydraulic accumulator, the connection of the accumulator to the hydraulic system must be blocked or opened as required to charge the accumulator by excess energy or to recover stored energy by discharging the accumulator.

For this purpose, a non-return function is required at the accumulator tap. If the system pressure is higher than the accumulator pressure, the accumulator is charged. If the system pressure is lower, the non-return function prevents the accumulator from discharging. In this respect, it is state of the art to use a unlockable non-return valve, wherein charging occurs in the direction of flow and a discharge process can be triggered by unlocking the valve. The non-return function can also be implemented by using a solenoid valve, which can be used to actively connect and disconnect the accumulator. However, the switching dynamics of common solenoid valves are not sufficient for use in hydraulic hybrid systems. Occurring switching delays cause undesired pressure increases in the system. By using an unlockable non-return valve higher switching dynamics are indeed realizable. However, the valve function does not prevent the accumulator from discharging below a minimum value of the accumulator pressure. If the accumulator is discharged below its pre-fill pressure, there is a risk of damage to the separating element of the accumulator concerned. A valve control device, disclosed in document DE 10 2016 006 545 A1 and connected to a hydraulic accumulator for a pressure adjustment, is also not suitable for a use in hydraulic hybrid applications.

Based on this state of the art, the invention addresses the problem of providing a system for charging and discharging at least one hydraulic accumulator, wherein said system particularly meets the demands on hydraulic hybrid applications.

According to the invention, this problem is solved by a system having the features of claim 1 in its entirety.

According to the characterizing part of claim 1, the invention is distinguished from the prior art in that a shuttle valve and a switching valve are provided and the valves are interconnected such that the hydraulically actuatable switching valve compares the accumulator pressure to a minimum accumulator pressure that can be adjusted via the control pressure setting of this switching valve. Because the valve control device of the system according to the invention operates without solenoid valve actuation, high switching dynamics are ensured. Further-more, because the shuttle valve and the switching valve are used to compare the accumulator pressure to an adjustable minimum accumulator pressure, the system according to the invention can also be operated reliably by setting the lowest accumulator pressure to an optimum pressure value for the operation of the pressure accumulator.

In a preferred embodiment of the system according to the invention, as long as the accumulator pressure is lower than the minimum accumulator pressure the switching valve is located in the valve position each caused by a, preferably adjustable, spring and by the control pressure and, in doing so, passes the accumulator pressure on to the one piston end of the piston of the logic valve, which, in this way acting as a non-return valve, prevents the respective hydraulic accumulator from being discharged below the set minimum accumulator pressure. In this way, damage to the separating element of the accumulator because of a pressure drop below the minimum accumulator pressure is effectively prevented.

In a further preferred embodiment of the system according to the invention, the valves are interconnected such that, as soon as the accumulator pressure is above the set minimum accumulator pressure, the switching valve changes to its actuated switching position and permits the, in particular inverse, shuttle valve to signal the respective lower of the two pressures in the form of the accumulator pressure and a system pressure of a hydraulic system, connected to the system, to the one piston side of the piston of the logic valve, which permits the flow through the logic valve in both directions, thus from the hydraulic accumulator to the hydraulic system and vice versa, such that the hydraulic accumulator can be both charged and discharged. If the accumulator pressure is above the system pressure, the hydraulic accumulator is discharged via the logic valve towards the hydraulic system; in the opposite case, if the accumulator pressure is lower than the system pressure, the hydraulic accumulator is charged by the hydraulic system via the logic valve.

In a preferred embodiment of the system according to the invention, an active shut-off device is provided, which comprises a solenoid valve that, unactuated or actuated via a further shuttle valve, signals the respective higher of the two pressures of accumulator pressure and system pressure to one side of the piston of the logic valve, which, in this way held in its closed position, shuts off the hydraulic accumulator from the hydraulic system and inactivates the hydraulic-mechanical accumulator control. Shutting off the accumulator can prevent an incidental charging of the accumulator during operating states in which the complete drive power is required to supply the hydraulic functions. In this way, the accumulator's ability to absorb excess energy is maintained in the further course of the work cycle. Also incidental charging of the accumulator during operating conditions is prevented, in which full drive power is required, which would result in a reduction in the available power that can be provided. The use of a solenoid valve as a pilot valve for the shut-off function is not critical, because only a low switching dynamic is required for this pilot function.

It is further advantageous that a discharging valve is provided for a safe discharge of the hydraulic accumulator into a tank port or return port, for instance during a machine standstill.

In a preferred embodiment of the system according to the invention, the logic valve forms a type of stepped piston on its side, opposite from the one side of the piston, wherein said stepped piston controls a fluid connection between the hydraulic system and the respective hydraulic accumulator.

The solenoid can be formed both de-energized open and de-energized closed. Alternatively, the adjustment of the control pressure for the switching valve can also be formed to be proportional to current or voltage.

Particularly advantageously, the system according to the invention is used to control the fluid-conveying connection between a hydraulic accumulator for energy recovery and a hydraulic system. In this way, the interconnection of valves can be used to charge, discharge and shut-off the hydraulic accumulator as required.

Below the invention is explained in detail with reference to exemplary embodiments shown in the drawing. In the Figures:

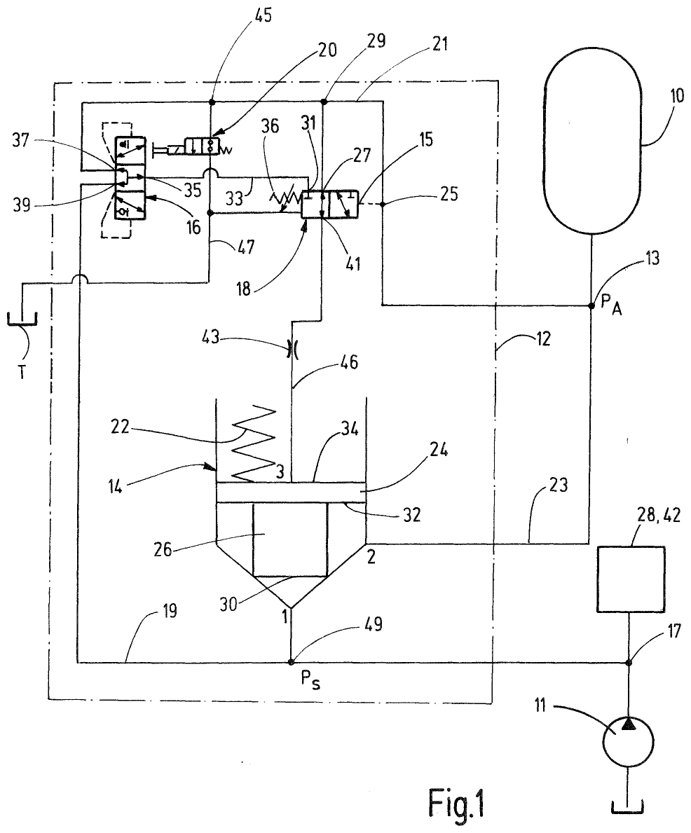

FIG. 1 shows a circuit diagram of a first exemplary embodiment of the system according to the invention for charging and discharging at least one hydraulic accumulator; and

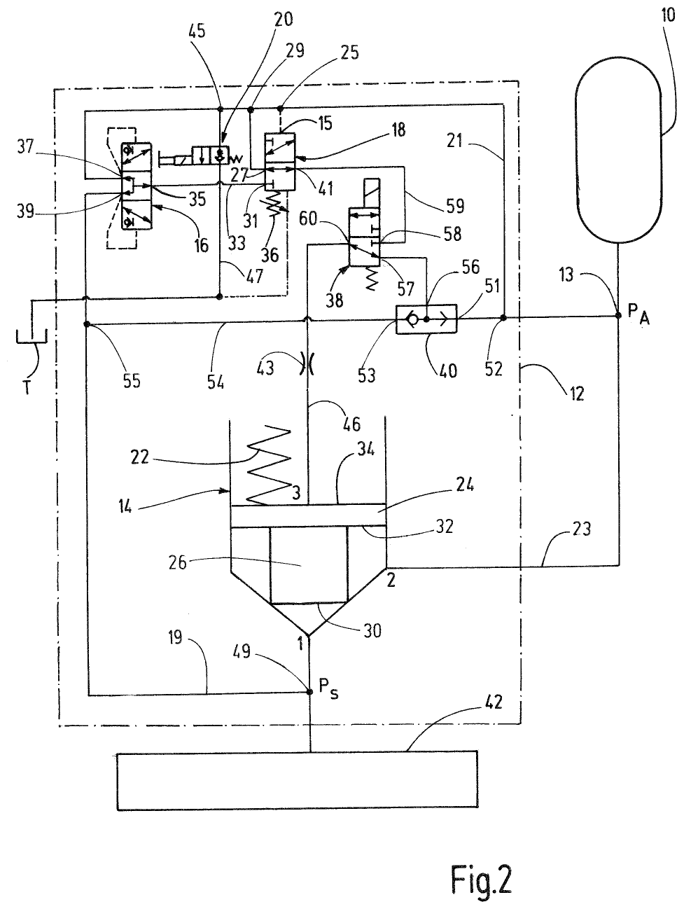

FIG. 2 shows a circuit diagram of a second exemplary embodiment of the system according to the invention for charging and discharging at least one hydraulic accumulator.

FIG. 1 shows a circuit diagram of a first exemplary embodiment of the system according to the invention, comprising a valve control device 12 connected to a hydraulic accumulator 10. To be used as an energy intermediate storage, the hydraulic accumulator 10 is connected to a hydraulic system 28, 42 via the valve control device 12, wherein said hydraulic system 28, 42 has a hydraulic consumer, for instance in the form of a working cylinder or traction drive with associated control electronics (all not shown). For pressure supply of the system by a system pressure pₛ a hydraulic pump 11 is provided, which can be driven by a drive motor, not shown, of an associated equipment, such as a mobile working device. For controlling the inflow and outflow of fluid to and from the accumulator tap 13 of the accumulator 10 the valve control device 12 has a logic valve 14 providing a non-return function.

The construction of the logic valve 14 matches that of the logic valve used in the aforementioned DE 10 2016 006 545 A1. The valve port, designated by the reference numeral 1, of the logic valve 14 is connected to the pressure side of the hydraulic pump 11, having the system pressure pₛ, and the valve port 2 of the logic valve 14 is connected to the accumulator tap 13, having the accumulator pressure p_{A}, of the accumulator 10. The valve port 3 of the logic valve 14 is connected to the output side of a hydraulically actuated switching valve 18. It is formed as a 3/2-way valve, which can be brought to the unactuated switching position, shown in FIG. 1, by means of an adjustable spring 36. For transfer to the actuated, second switching position, the control port 15 of the switching valve 18 is connected to the accumulator tap 13, having the accumulator pressure p_{A}. The outlet port 41 of the switching valve 18 is connected to the valve port 3 of the logic valve 14, such that the effective surface area 34 of the piston 24 of the logic valve 14 can be loaded with control pressure, which can be supplied from the switching valve 18.

An input-sided valve port 27 of the switching valve 18 is connected to the accumulator tap 13 and therefore pressurized to the accumulator pressure p_{A}. The second input-sided valve port 31 of the switching valve 18 is connected to the output 35 of an inverse shuttle valve 16. One input 39 of the shuttle valve 16 is pressurized to the system pressure pₛ, whereas the other input 37 of the shuttle valve is connected to the accumulator tap 13 and pressurized to the accumulator pressure p_{A}.

As an inversely operating shuttle valve 16, its output 35 signals the respective lower pressure value of the system pressure pₛ or the accumulator pressure p_{A} of the accumulator tap 13 to the input port 31 of the switching valve 18. As long as the accumulator pressure p_{A} is lower than the minimum accumulator pressure p_{A0}, set by the spring 36, the switching valve 18 is in the unactuated position shown, in which it signals the accumulator pressure p_{A} to the effective surface area 34 of the piston 24 of the logic valve 14. As a result, the logic valve 14 acts as a non-return valve blocking the flow from the accumulator tap 13, such that the accumulator 10 can only be charged from the pressure side 17, having the system pressure pₛ, of the hydraulic pump 11. If the accumulator pressure p_{A} is above the set minimum pressure value, then the switching valve 18 changes to the actuated switching position and permits the inverse shuttle valve 16 to signal the respective lower of the two pressures p_{A} and pₛ to the effective surface area 34 of the piston 24 of the logic valve 14. As a result of that the lower pressure is acting on the effective surface area 34 of the piston 24 of the logic valve 14, the latter now allows flow in both directions, i.e. the accumulator 10 can be both charged and discharged.

The interconnection of the above components has, as a first line main branch, a pressure line 19, pressurized to the system pressure pₛ, wherein said pressure line 19 runs from the pressure side 17 of the hydraulic pump 11 to the first inlet 39 of the shuttle valve 16 and to said pressure line 19, at a junction 49, the valve port 1 of the logic valve 14 is connected. As a second main branch an accumulator pressure line 21 is provided, pressurized to the accumulator pressure p_{A} and forming the connection between the accumulator tap 13 and the second inlet 37 of the shuttle valve 16. As a third main branch an accumulator charge-discharge line 23 is provided, which runs from the accumulator tap 13 to the valve port 2 of the logic valve 14. The output port 41 of the switching valve 18 is connected to the valve port 3 of the logic valve 14 via a control line 46, in which an orifice 43 is located. On the input side, the first input port 27 of the switching valve 18 is connected to the accumulator pressure line 21 at a junction 29 and the second input port 31 of the switching valve 18 is connected to the output 35 of the shuttle valve 16 via a line 33. For its comparison function, for which the accumulator pressure p_{A} counteracts the set force of the spring 36, the control port 15 is connected to the accumulator pressure line 21 at a junction 25. The circuit is completed by a discharge valve 20, which can be actuated electromagnetically and which inlet-sided is connected to the accumulator pressure line 21 at a junction 45 and thus to the hydraulic accumulator 10, and which is outlet-sided connected to the tank port T or return port via a tank line 47.

For its lock/non-return function, the logic valve 14, as disclosed in the aforementioned document DE 10 2016 006 545 A1, is formed by a 2-way built-in valve, whose control piston 24 has three effective surface areas 30, 32 and 34 as well as a piston step 26 having a control geometry. The pressure of the valve port 1, which is connected to the junction 49 of the pressure line 19 and is pressurized to the system pressure pₛ, acts on the effective surface area 30. The second effective surface area 32 is exposed to the pressure from the valve port 2 and is sized less than one hundredth of the size of the first effective surface area 30. Accordingly, the third effective surface area 34, which is pressurized by the fluid pressure at the valve port 3, forms the largest effective surface area and corresponds to the sum of the effective surface areas 30 and 32. The prestress of the spring 22 presses the piston step 26, forming a control pin, of the valve piston 24 into the seat. In this position, in which the volume flow through the logic valve 14 is blocked, the piston 24 is held by the accumulator pressure, acting at the effective surface area 34, when the switching valve 18 is arranged in the switching position, shown in FIG. 1, whereas in the actuated position of the switching valve 18 and the then lower respective pressure of pₛ and p_{A} at the effective surface area 34, the flow through the logic valve 14 is permitted in accordance with the pressures present at the valve ports 1 and 2.

FIG. 2 shows the circuit diagram of a second exemplary embodiment of the system according to the invention. The second exemplary embodiment is described only to the extent that it differs substantially from the first exemplary embodiment, and the explanations given so far also apply to the second exemplary embodiment. It differs in particular from the first example in that it comprises a shut-off device, that can be activated and by means of which the function of the control device 12 can be deactivated. The shut-off device has an electromagnetically actuated shift valve 38 in the form of a 3/2-way valve and a shuttle valve 40. One input 51 thereof is connected to a junction 52 of the accumulator pressure line 21 and the second input 53 thereof is connected to a junction 55 of the pressure line 19 via a connecting line 54. In this arrangement, the output 56 of the shuttle valve 40 signals the respective higher pressure of accumulator pressure p_{A} and system pressure pₛ to a first input 57 of shift valve 38. The second input 58 of the shift valve 38 is connected to the output port 41 of the switching valve 18 via a line 59. The control line 46 is connected to the output port 60 of the shift valve 38, wherein said control line 46 runs to the valve port 3 of the logic valve 14.

In the unactuated switching position, as shown in FIG. 2, the shift valve 38 signals the respective higher pressure, supplied by the shuttle valve 40, of the accumulator pressure p_{A} and the system pressure pₛ to the effective surface area 34 of the logic valve 14, such that the latter remains in the shut-off state and in this way the accumulator 10 is safely shut off from the system. In the actuated state of the shift valve 38, as in the example of FIG. 1, the output port 41 of the switching valve 18 is in turn connected to the control line 46 via the line 59 and the output port 60, as in FIG. 1 is the case, such that the control function of the valve control device 12 is in turn activated. The shift valve 38 may be formed to be de-energized open or de-energized closed. Optionally, a minimum pressure setting proportional to current or voltage may also be provided for the switching valve 18.

1. A system for charging and discharging at least one hydraulic accumulator (10), which can be connected to a valve control device (12), wherein the valve control device (12) comprises at least one logic valve (14), characterized in that a shuttle valve (16) and a switching valve (18) are also provided and the valves (14, 16, 18) are interconnected such that the hydraulically actuatable switching valve (18) compares the accumulator pressure (pA) to a minimum accumulator pressure (pA0) that can be adjusted via the control pressure setting of this switching valve (18).

2. The system according to claim 1, characterized in that as long as the accumulator pressure (pA) is lower than the minimum accumulator pressure (pA0), the switching valve (18) is located in the valve position each caused by a, preferably adjustable, spring (36) and by the control pressure and, in doing so, passes the accumulator pressure (pA) on to the one piston end (34) of the piston (24) of the logic valve (14), which, in this way acting as a non-return valve, prevents the respective hydraulic accumulator (10) from being discharged below the set minimum accumulator pressure (pA0).

3. The system according to claim 1, characterized in that the valves (14, 16, 18, 20) are interconnected in such a way that, as soon as the accumulator pressure (pA) is higher than the set minimum accumulator pressure (pA0), the switching valve (18) changes to its actuated switching position and permits the shuttle valve (16) to signal the respective lower pressure of the two pressures in the form of the accumulator pressure (pA) and a system pressure (pS) of a hydraulic system (42), connected to the system, to the one piston side (34) of the piston (24) of the logic valve (14), which permits the flow through the logic valve (14) in both directions, thus from the hydraulic accumulator (10) to the hydraulic system (42) and vice versa, such that the hydraulic accumulator (10) can be both charged and discharged.

4. The system according to claim 1, characterized in that an active shut-off device is provided, which comprises a solenoid valve (38) that, unactuated or actuated via a further shuttle valve (40), signals the respective higher of the two pressures of accumulator pressure (pA) and system pressure (pS) to one side (34) of the piston (24) of the logic valve (14), which, in this way held in its closed position, shuts off the hydraulic accumulator (10) from the hydraulic system (42) and inactivates the hydraulic-mechanical accumulator control.

5. The system according to claim 1, characterized in that a discharging valve (20) is provided for a safe discharge of the hydraulic accumulator (10) into a tank port (T) or return port (T).

6. The system according to claim 1, characterized in that the logic valve (14) forms a type of stepped piston (26) on its side, opposite from the one side (34) of the piston (24), wherein said stepped piston (26) controls a fluid connection between the hydraulic system (42) and the respective hydraulic accumulator (10).

7. The system according to claim 1, characterized in that the solenoid valve (38) can be formed to be de-energized open or de-energized closed.

8. The system according to claim 1, characterized in that the adjustment of the control pressure for the switching valve (18) can also be formed to be proportional to current or voltage.

9. The system according to claim 1, characterized in that it is used to control the fluid-conveying connection between a hydraulic accumulator (10) for energy recovery and a hydraulic system (42).
